(19) United States
(12) Patent Application Publication
(10) Pub. No.: US 2026/0233200 A1
(43) Pub. Date: Aug. 13, 2026

(54) COATING SOLUTION FOR PREPARATION OF REFORMING CATALYST TO WHICH INSULATION SUPPORT IS APPLIED, AND REFORMING CATALYST PREPARATION METHOD

(71) Applicant: JOONG-IL MATERIALS INC., Incheon (KR)

(72) Inventors: Tae Jung LEE, Seoul (KR); Byung Gwan GWAK, Incheon (KR); Chang Dae OH, Incheon (KR)

(21) Appl. No.: 19/156,790

(22) PCT Filed: Feb. 15, 2024
(86) PCT No.: PCT/KR2024/095224

§ 371 Date: Aug. 14, 2025

(30) Foreign Application Priority Data
Mar. 24, 2023 (KR) 10-2023-0038354

(51) Int. Cl. B01J 21/12; B01J 23/46; B01J 37/02; B01J 37/08; C01B 3/40

(52) U.S. Cl. CPC B01J 21/12; B01J 23/462; B01J 37/0201; B01J 37/0228; B01J 37/0236; B01J 37/024; B01J 37/08; C01B 3/40; C01B 2203/1064; C01B 2203/1082; C01B 2203/1241

(57) ABSTRACT

In order to provide a reforming catalyst that can be easily and economically prepared in various shapes, can reduce the amount of catalyst used, is stable even in high-temperature reactions, and has excellent durability, the present disclosure provides: a pre-coating solution including a reinforcing solution containing a silica sol, an alumina sol, and a solvent; and a catalyst powder; and a catalyst coating solution including an inorganic binder containing a silica sol and an alumina sol, and a catalyst aqueous solution including a solvent and a catalyst powder, and provides a method for preparing a reforming catalyst, the method including: a pre-coating step of manufacturing a pre-coated insulating material support by using a pre-coating solution; a firing step of heating and firing the pre-coated insulating material support; and a catalyst coating step of preparing a reforming catalyst by coating a catalyst coating solution on the pre-coated insulating material support.

### CROSS-REFERENCE TO RELATED APPLICATIONS

This application is the National Stage filing under 35 U.S.C. 371 of International Application No. PCT/KR2024/095224, filed on Feb. 15, 2024, which claims the benefit of Korean Patent Application No. 10-2023-0038354, filed on Mar. 24, 2023, the contents of which are all hereby incorporated by reference herein in their entirety.

### TECHNICAL FIELD

The present disclosure relates to a reforming catalyst having an insulating material support applied thereto, and more specifically, to a coating solution composition for preparing a reforming catalyst having an insulating material support applied thereto and a method for preparing a reforming catalyst having an insulating material support applied thereto.

### BACKGROUND ART

Recently, each country and company is making great efforts to respond to environmental pollution and global warming. In particular, since fossil fuels are currently the most widely used energy source, but they have a great impact on environmental pollution and global warming, much effort is being made to secure alternative energy to replace them. In particular, one of the methods for producing hydrogen, a promising alternative energy source, is to convert fossil fuels such as methane, methanol, gasoline, and natural gas into hydrogen using a reformer, and includes a steam reforming reaction, a partial oxidation reaction, an autothermal reforming reaction, etc.

These reforming reactions generally use nickel (Ni), a transition metal with low price, mainly as a catalyst material, and when nickel is used as a catalytically active material, CO is adsorbed on the nickel surface so that a reaction occurs in which carbon is deposited. To solve such a problem, efficiency and stability can be increased by using nickel in the form in which a precious metal, which is a catalytically active material, is supported or impregnated on alumina (Al2O3) with a large surface area. However, the precious metal has a high price range compared to nickel metal.

In general, catalyst is prepared as powder, the catalyst is molded and processed into the forms such as spheres, cylinders, pellets, etc. depending on the reaction conditions and state, and then compression-molded into the form of spheres or pellets of a certain size and used. However, reforming catalysts processed in this way require expensive equipment for the molding method, and have the disadvantage of increasing the preparation cost due to the large amount of catalyst input. To compensate for these disadvantages, alumina-based catalyst supports are used to coat the surface with catalysts and use them in pellet form. However, since reforming reactions are very severe endothermic or exothermic reactions that occur at high temperatures, alumina-based support catalysts have the disadvantage of low start-up time and low thermal efficiency due to slow heat transfer rates.

Accordingly, it is necessary to develop reforming catalysts that can be easily and economically prepared in various shapes suitable for the reaction, are economical because they can reduce the amount of catalyst used, are stable even in high-temperature reactions, and have excellent durability.

### DISCLOSURE

### Technical Problem

In order to solve the problems as described above, an object of the present disclosure is to provide a reforming catalyst that can be easily and economically prepared in various shapes, can reduce the amount of catalyst used, is stable even in high-temperature reactions, and has excellent durability.

### Technical Solution

In order to provide a reforming catalyst to which an insulating material support is applied, the present disclosure provides a pre-coating solution including: a reinforcing solution which is coated on an insulating material support including silica and alumina and contains a silica sol, an alumina sol, and a solvent; and a catalyst powder.

Furthermore, in order to provide a reforming catalyst to which an insulating material support is applied, the present disclosure provides a catalyst coating solution including: an inorganic binder which is coated on a pre-coated insulating material support, and contains a silica sol and an alumina sol; and a catalyst aqueous solution including a solvent and a catalyst powder, wherein the pre-coated insulating material support is formed by coating a pre-coating solution containing a silica sol and an alumina sol on an insulating material support containing silica and alumina.

Furthermore, in order to provide a reforming catalyst to which an insulating material support is applied, the present disclosure provides a method for preparing a reforming catalyst, the method including: a pre-coating step of manufacturing a pre-coated insulating material support by coating and forming a pre-coating solution containing a silica sol and an alumina sol on an insulating material support containing silica and alumina; a firing step of heating and firing the pre-coated insulating material support; and a catalyst coating step of preparing a reforming catalyst by coating a catalyst coating solution including an inorganic binder containing a silica sol and an alumina sol and a catalyst aqueous solution including a solvent and a catalyst powder on the pre-coated insulating material support.

### Advantageous Effects

According to one embodiment of the present disclosure, a reforming catalyst to which an insulating material support is applied can be easily and economically prepared in various shapes.

In addition, according to one embodiment of the present disclosure, as an insulating material support is applied, the amount of catalyst used when preparing a reforming catalyst can be reduced.

In addition, according to one embodiment of the present disclosure, as a reforming catalyst to which an insulating material support is applied is used, a catalytic reaction can be stably performed even in high temperature reactions.

In addition, according to one embodiment of the present disclosure, a reforming catalyst to which an insulating material support having excellent durability is applied can be provided.

### DESCRIPTION OF DRAWINGS

FIG. 1 is a schematic diagram of a method for preparing a reforming catalyst to which an insulating material support is applied according to one embodiment of the present disclosure.

FIG. 2 is a graph showing the CH₄ reforming reaction measured for 350 hours using a reforming catalyst prepared according to Example 1.

### MODE FOR DISCLOSURE

Hereinafter, embodiments of the present disclosure will be described in detail. However, the present disclosure is not limited to the embodiments disclosed below, but can be implemented in various different forms, and the present embodiments are provided only to make the disclosure of the present disclosure complete and to more completely inform those skilled in the art of the contents of the present disclosure.

The present disclosure is for preparing a reforming catalyst to which an insulating material support is applied, provides a pre-coating solution for improving the strength of an insulating material support and a catalyst coating solution for coating a catalyst on the insulating material support, and provides a method for preparing a reforming catalyst to which the insulating material support is applied using the pre-coating solution and the catalyst coating solution. Accordingly, a reforming catalyst having excellent durability by securing the strength so that an insulating material having low density and low mechanical strength can be used as a support for a reforming catalyst can be provided, and can provide a reforming catalyst that is economical by being stable even in high-temperature reactions and enabling the amount of catalyst used to be reduced as the insulating material support is applied.

At this time, it is preferable that the insulating material support has an insulating material that has a large surface area and low thermal conductivity, is physically/chemically stable, prepared with safe materials, is easy to process, and has a low unit price applied thereto. In particular, an insulating material to which silica with excellent thermal stability and alumina with excellent strength are applied is preferable. For example, the insulating material may have an insulating material formed of 46 to 85% of Al₂O₃, 10 to 52% of SiO₂ at a density of 350±35 kg/m³ applied thereto, but is not limited thereto.

Hereinafter, the pre-coating solution and the catalyst coating solution of the present disclosure will be described in detail.

The pre-coating solution according to the present disclosure includes a reinforcing solution containing a silica sol, an alumina sol, and a solvent, and a catalyst powder.

In the pre-coating solution, the reinforcing solution and the catalyst powder may be mixed at a weight ratio of 98.0 to 100:0 to 2.0. The main purpose of the pre-coating solution is for preparing a pre-coated insulating material support using the reinforcing solution. At this time, the pre-coating solution can improve the mechanical strength and durability of the outer side of the pre-coated insulating material support prepared by densifying some of the surface pores of the insulating material support. Accordingly, the strength and durability of the reforming catalyst to which the insulating material support is applied can be improved.

In addition, in the pre-coating solution, increasing the input ratio of the reinforcing solution is advantageous in securing the strength and durability of the reforming catalyst, and a small amount of the catalyst powder is added, thereby enabling the catalyst powder to be distributed in advance on the surface of the pre-coated insulating material support, so that the performance of the reforming catalyst can be effectively and stably exhibited.

The reinforcing solution may include 45.0 to 55.0% by weight of the silica sol, 32.5 to 42.5% by weight of the alumina sol, and a balance of the solvent. Accordingly, since the insulating material support, in which Al₂O₃ and SiO₂ are the main components, and the reinforcing solution have the same components, the pre-coating solution may be well coated on the surface of the insulating material support.

For example, the silica sol may be a dispersion in which SiO₂ particles are dispersed at a content of 27 to 33% by weight, and a silica sol having a size of the SiO₂ particles of 8 to 25 nm may be applied. In addition, the alumina sol may be a dispersion in which Al₂O₃ particles are dispersed at a content of 5 to 20% by weight, and an alumina sol having a size of the Al₂O₃ particles of 15 to 170 nm may be applied.

In the reinforcing solution, if the ratios of the silica sol and the alumina sol are lowered, the surface coating ability of the insulating material support may be reduced. For example, when the reinforcing solution contains less than 45.0% by weight of a silica sol and less than 32.5% by weight of an alumina sol, when the silica sol and the alumina sol are coated on the surface of the insulating material support, the ability to densify a portion of the surface pores is reduced, and the mechanical strength and durability of the outer side of the pre-coated insulating material support may be adversely affected.

In addition, in the reinforcing solution, if the silica sol ratio increases, the strength of the pre-coated insulating material support may decrease. For example, if the silica sol exceeds 55.0% by weight, the surface of the insulating material support may be excessively coated with silica particles, so that the outer side of the pre-coated insulating material support may have physical properties of being easily broken by external impact, which may adversely affect the mechanical strength and durability.

In addition, in the reinforcing solution, if the alumina sol ratio increases, the thermal stability of the pre-coated insulating material support may decrease. For example, if the alumina sol exceeds 42.5% by weight, the surface of the insulating material support may be excessively coated with alumina particles, so that the thermal conductivity of the surface of the pre-coated insulating material support increases, which may adversely affect the thermal stability of the catalyst formed on the surface of the pre-coated insulating material support.

Water may be applied as the solvent. For example, distilled water and DI-water may be applied, but the present disclosure is not limited thereto. Accordingly, environmental problems and safety problems that may arise when using organic solvents can be prevented, and an increase in the firing and drying time required to completely remove the organic solvents can be prevented.

In addition, an aqueous solution containing 0 to 2% of an organic material in distilled water and DI-water may be applied as the solvent. For example, the organic material may be applied as methyl cellulose, PVA, etc., but the present disclosure is not limited thereto. Accordingly, the SiO₂ particles of the silica sol and the alumina sol, and the Al₂O₃ particles may be well attached to the surface of the insulating material support by the organic material. At this time, if the organic material exceeds 2%, the viscosity is high, so that the dispersion power of the powder inside the reinforcing solution decreases, making it difficult to achieve a constant coating, and the firing and drying time required to completely remove the organic material may increase, which is not preferable.

Catalysts in which precious metals of Ru, Pt, Rh, and Pd are used as catalysts based on Ni, Zn, Al, Zr, and Ce may be applied as the catalyst powder, but the present disclosure is not limited thereto. In addition, the catalyst powder may be processed into a powder form of less than 10 μm and mixed. Accordingly, the catalyst powder may be uniformly dispersed in the solvent and uniformly coated on the surface of the insulating material support.

The pre-coating solution may further contain an additive including SiO₂ having a particle size of 4 μm or less. For example, the additive may be further added in an amount of 0.1 to 3.0% by weight based on the weight of the reinforcing solution. Accordingly, on the surface of the insulating material support made of a porous material, a portion with a large pore size or a surface of the insulating material support processed into various shapes can be effectively densified, thereby improving the mechanical strength and durability of the pre-coated insulating material support.

At this time, if the input amount of the additive is excessively high, the strength of the pre-coated insulating material support may be reduced. For example, if the input amount of the additive exceeds 3.0% of the weight of the reinforcing solution, the surface of the insulating material support may be excessively coated with silica particles, so that the outer side of the pre-coated insulating material support may have physical properties of being easily broken by external impact, which may adversely affect the mechanical strength and durability.

The catalyst coating solution according to the present disclosure includes an inorganic binder containing a silica sol and an alumina sol, and a catalyst aqueous solution containing a solvent and a catalyst powder.

The catalyst coating solution may contain 2.6 to 5.2% by weight of the inorganic binder and the remainder of the catalyst aqueous solution. The main purpose of the catalyst coating solution is to prepare the reforming catalyst by coating the surface of the pre-coated insulating material support with a catalyst. For example, if the content of the inorganic binder in the catalyst coating solution is less than 2.6% by weight, the ratio of the inorganic binder to the catalyst powder decreases, which may adversely affect the stable attachment of the catalyst powder to the surface of the pre-coated insulating material support, and may adversely affect the mechanical strength and durability. In addition, if the content of the inorganic binder in the catalyst coating solution exceeds 5.2% by weight, the ratio of the inorganic binder to the surface of the pre-coated insulating material support increases, and the ratio of the catalyst powder relatively decreases, which may cause the fuel conversion rate to decrease, and the efficiency may decrease compared to the amount of the catalyst powder input.

The inorganic binder may be mixed with the silica sol and the alumina sol at a weight ratio of 1 to 5:0 to 4. Accordingly, since the insulating material support, in which Al₂O₃ and SiO₂ are the main components, and the inorganic binder have the same components, the catalyst coating solution may be well coated on the surface of the pre-coated insulating material support, and the catalyst powder particles may be well attached to the surface of the pre-coated insulating material support.

For example, the silica sol may be a dispersion in which SiO₂ particles are dispersed at a content of 27 to 33% by weight, and a silica sol having a size of the SiO₂ particles of 8 to 25 nm may be applied. In addition, the alumina sol may be a dispersion in which Al₂O₃ particles are dispersed at a content of 5 to 20% by weight, and an alumina sol having a size of the Al₂O₃ particles of 15 to 170 nm may be applied. Accordingly, the catalyst powder may be stably attached to the surface of the pre-coated insulating material support by the inorganic binder.

The catalyst aqueous solution may have the solvent and the catalyst powder mixed therein at a weight ratio of 89 to 91:9 to 11. For example, when the catalyst powder is contained in the solvent at a weight ratio of less than 9 or the catalyst powder is contained in the solvent at a weight ratio of more than 11, the catalyst powder may not be evenly coated on the surface of the pre-coated insulating material support.

Catalysts in which precious metals of Ru, Pt, Rh, and Pd are used as catalysts based on Ni, Zn, Al, Zr, and Ce may be applied as the catalyst powder, but the present disclosure is not limited thereto. In addition, the catalyst powder may be processed into a powder form of less than 10 μm and mixed. Accordingly, the catalyst powder may be uniformly dispersed in the solvent and uniformly coated on the surface of the pre-coated insulating material support.

Water may be applied as the solvent. For example, distilled water and DI-water may be applied, but the present disclosure is not limited thereto.

In addition, an aqueous solution containing 0 to 2% of an organic material in distilled water and DI-water may be applied as the solvent. For example, the organic material may be applied as methyl cellulose, PVA, etc., but the present disclosure is not limited thereto. Accordingly, the catalyst powder particles may be well attached to the surface of the pre-coated insulating material support by the organic material. At this time, if the organic material exceeds 2%, the viscosity is high, so that the dispersion power of the catalyst powder inside the reinforcing solution decreases, making it difficult to achieve a constant coating, and the firing and drying time required to completely remove the organic material may increase, which is not preferable.

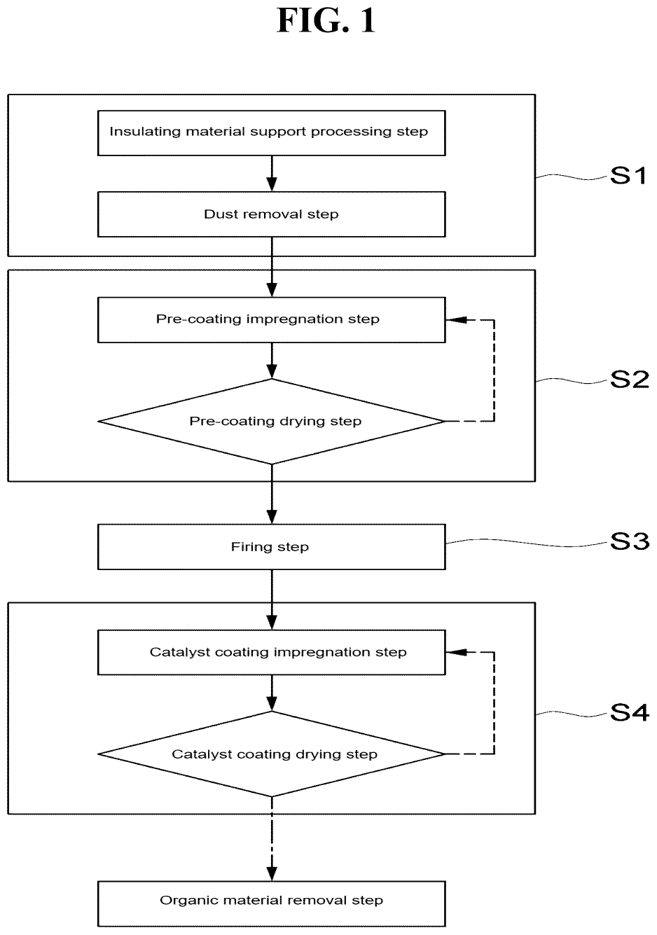

Hereinafter, with reference to FIG. 1, a method for preparing a reforming catalyst to which the insulating material support is applied using the pre-coating solution and the catalyst coating solution will be described in detail.

FIG. 1 is a schematic diagram of a method for preparing a reforming catalyst to which an insulating material support is applied according to one embodiment of the present disclosure.

The method for preparing a reforming catalyst to which an insulating material support is applied according to the present disclosure includes an insulating material support preparation step (S1), a pre-coating step (S2), a firing step (S3), and a catalyst coating step (S4).

The insulating material support preparation step (S1) is a step for preparing an insulating material support of the reforming catalyst, and may include an insulating material support processing step and a dust removal step.

The insulating material support processing step is a step of processing the insulating material support into various shapes. At this time, the insulating material support can be processed into various shapes. For example, it can be processed into a cube, a rectangular parallelepiped, a spherical shape, a pellet shape, a cylindrical shape, and a cylinder shape, but the present disclosure is not limited thereto, and various irregularity processing is also possible on the surface of the insulating material support, but the present disclosure is not limited thereto.

In addition, the insulating material support may have a size of the long side portion of 5 mm or more. At this time, in order to maximally utilize the effect of the insulating material support, it is advantageous if the difference between the long side and the short side is not large, such as a spherical shape or a cube. For example, if the insulating material support is processed into a shape with a large difference between the long side and the short side, the insulating material support cannot form a sufficient volume, and thus the insulation effect cannot be sufficiently exerted, resulting in poor thermal stability and reduced efficiency of the catalytic reaction. In addition, if the size of the insulating material support is processed to be less than 5 mm, it is difficult to obtain the same shape due to durability, resulting in a low processing yield, which is not desirable.

The dust removal step is a step of removing foreign substances attached to the surface of the insulating material support. For example, since dust generated during the processing of the insulating material support may be attached to the surface of the insulating material support, this may be removed using various methods such as a brush, a blower, or the like. Accordingly, when coating the insulating material support, it is possible to prevent uneven coating portions or uncoated portions from being formed on the coating surface due to foreign substances attached to the surface of the insulating material support.

The pre-coating step (S2) is a step of coating the insulating material support using the pre-coating solution to manufacture a pre-coated insulating material support, and may include a pre-coating impregnation step and a pre-coating drying step.

The pre-coating impregnation step is a step of impregnating a plurality of the insulating material supports with the pre-coating solution. At this time, it is preferable that the pre-coating solution and the insulating material supports are prepared at a volume ratio of 1.8 to 2.2:1. For example, when the pre-coating solution ratio is less than 1.8, the surface coating ability of the insulating material supports may be reduced. In addition, when the pre-coating solution ratio exceeds 2.2, waste of the pre-coating solution may occur.

In the pre-coating impregnation step, when impregnating a plurality of the insulating material supports with the pre-coating solution, the insulating material supports may be impregnated in a state that the pre-coating solution is being stirred. For example, a plurality of the insulating material supports may be placed in a strainer with 1,000 to 2,000 meshes and impregnated in a mixing container in which the pre-coating solution is being stirred. Accordingly, the insulating material supports may be stably impregnated without moving within the mixing container according to stirring of the pre-coating solution, and damage to the insulating material supports due to the stirring thereof can be prevented.

The stirring condition of the pre-coating solution in the pre-coating impregnation step is preferably performing stirring at room temperature and 100 to 300 RPM. For example, when the stirring condition is less than 100 RPM, a plurality of the insulating material supports may not be evenly coated, and when the stirring condition exceeds 300 RPM, bubbles may be generated, or the surface coating ability of the insulating material supports may be reduced due to excessive mixing.

The pre-coating drying step is a step of taking out the insulating material supports after the completion of the pre-coating impregnation step and drying them. For example, hot air drying, infrared drying, and a combination thereof may be applied, but the present disclosure is not limited thereto. In addition, in order for the insulating material supports to be evenly dried, it is preferable to evenly spread the insulating material supports so that they do not overlap with each other and dry them.

Accordingly, in the pre-coating drying step, SiO₂ and Al₂O₃, which were stained along with the solvent to the surface of the insulating material supports, are attached to the surface of the insulating material supports to form a coating film, and the solvent and organic materials may be removed.

In addition, since SiO₂ and Al₂O₃ are integrated with the surface of the insulating material supports, the strength of the surface of the insulating material supports can be improved, and dust generated on the surface of the insulating material supports can be blocked, thereby preventing a phenomenon that the catalyst coated on the pre-coated insulating material supports is easily peeled off due to dust.

The pre-coating drying step is preferably performing drying at a drying temperature of 180 to 220° C. for 0.5 to 1.5 hours. For example, if the drying temperature is lower than 180° C., sufficient heat is not applied, and thus it may be difficult to stably form a coating film by the pre-coating solution on the surface of the insulating material supports. In addition, if the drying temperature exceeds 220° C., not less than heat sufficient for the pre-coating solution to form a coating film on the surface of the insulating material supports may be applied, which may result in a decrease in process efficiency due to unnecessary energy use.

In addition, if the drying time is less than 0.5 hours, the coating film by the pre-coating solution may not be stably formed on the surface of the insulating material supports, and if the drying time exceeds 1.5 hours, after the coating film by the pre-coating solution is sufficiently formed on the surface of the insulating material supports, a decrease in process efficiency due to unnecessary energy use may occur.

The pre-coating step (S2) may repeat the pre-coating impregnation step and the pre-coating drying step one or more times. For example, the pre-coating impregnation step and the pre-coating drying step may be repeated one or more times until the coating amount calculated by calculating the density difference based on the weight difference between the pre-coated insulating material supports on which the pre-coating drying step has been completed and the insulating material supports before the pre-coating step (S2) is introduced becomes 150 to 300 kg/m³ (0.15 to 0.30 g/cm³). At this time, in the pre-coating step (S2), the pre-coating solution penetrates into the pores of the insulating material supports and is coated, so that the change in volume can be ignored when calculating the density. Accordingly, pre-coated insulating material supports can be effectively manufactured.

The firing step (S3) is a step of heating and firing the pre-coated insulating material supports that have completed the pre-coating step (S2). For example, the firing step (S3) may have various heating furnaces that apply hot air heating, infrared heating, and a combination thereof applied thereto, but the present disclosure is not limited thereto. At this time, the heating condition is preferably to raise the temperature at a temperature rising rate of 5 to 10° C./min to a target temperature of 700 to 1,000° C. and then maintain it for 6 to 12 hours.

The firing step (S3) is a task of forming a coating film on the surface of the pre-coated insulating material supports from which all solvents and organic materials have been removed while raising the temperature to the target temperature, and shrinking the pre-coated insulating material supports in advance at a high temperature before coating the catalyst on the pre-coated insulating material supports including pores, thereby treating the pre-coated insulating material supports so that the reaction area of the pre-coated insulating material supports can be properly utilized. Accordingly, if the target temperature is less than 700° C., additional shrinkage may occur when the reforming catalyst to which the pre-coated insulating material supports are applied is used at a high temperature, which may lower the efficiency of the reforming catalyst, and if the target temperature exceeds 1000° C., the temperature is a temperature not less than sufficient to shrink the pre-coated insulating material supports, which may lower the process efficiency due to unnecessary energy use.

In addition, if the temperature rising rate is less than 5° C./min, it may excessively take long to reach the target temperature, which may lower the process efficiency. If the temperature rising rate exceeds 10° C./min, deformation of the pre-coated insulating material supports may occur due to rapid temperature increase.

In the firing step (S3), firing may not be fully completed if the operation is performed for less than 6 hours after reaching the target temperature, and if the operation is performed for more than 12 hours, a decrease in process efficiency may occur due to unnecessary energy and time consumption after the firing is fully completed.

The catalyst coating step (S4) is a step of coating the pre-coated insulating material supports that have completed the firing step (S3) using the catalyst coating solution to produce the reforming catalyst, and may include a catalyst coating impregnation step and a catalyst coating drying step.

The catalyst coating impregnation step is a step of impregnating a plurality of the pre-coated insulating material supports that have completed the firing step (S3) with the catalyst coating solution. At this time, it is preferable that the catalyst coating solution and the pre-coated insulating material supports are prepared at a volume ratio of 1.8 to 2.2:1. For example, if the catalyst coating solution ratio is less than 1.8, the coating ability on the surface of the pre-coated insulating material supports may be reduced. In addition, when the catalyst coating solution ratio exceeds 2.2, waste of the catalyst coating solution may occur.

In the catalyst coating impregnation step, when impregnating a plurality of the pre-coated insulating material supports with the catalyst coating solution, the pre-coated insulating material supports may be impregnated in a state that the catalyst coating solution is being stirred. For example, a plurality of the pre-coated insulating material supports may be placed in a strainer with 1,000 to 2,000 meshes and impregnated in a mixing container in which the catalyst coating solution is being stirred.

Accordingly, the pre-coated insulating material supports may be stably impregnated without moving within the mixing container according to stirring of the catalyst coating solution, and damage to the pre-coated insulating material supports can be prevented.

The stirring condition of the catalyst coating solution in the catalyst coating impregnation step is preferably performing stirring at room temperature at a stirring condition of 100 to 300 RPM. For example, if the stirring condition is less than 100 RPM, a plurality of the pre-coated insulating material supports may not be evenly coated, and if the stirring condition exceeds 300 RPM, bubbles may generate, or the surface coating ability of the pre-coated insulating material supports may be reduced due to excessive mixing.

The catalyst coating drying step is a step of taking out the pre-coated insulating material supports after the catalyst coating impregnation step is completed and drying the pre-coated insulating material supports. For example, hot air drying, infrared drying, and a combination thereof may be applied, but the present disclosure is not limited thereto. In addition, in order for the insulating material supports to be evenly dried, it is preferable to evenly spread the insulating material supports so that they do not overlap each other and dry them.

Accordingly, in the catalyst coating drying step, SiO₂, Al₂O₃, and the catalyst powder, which were stained along with the solvent to the surface of the pre-coated insulating material supports are attached to the surface of the pre-coated insulating material supports to form a coating film, and the solvent and organic materials may be removed. In addition, since SiO₂, Al₂O₃, and the catalyst powder are integrally attached to the surface of the pre-coated insulating material supports, the catalyst powder may be stably attached to the surface of the pre-coated insulating material supports.

The catalyst coating drying step is preferably performed at a drying temperature of 180 to 220° C. for a drying time of 0.5 to 1.5 hours. For example, since sufficient heat is not applied when the drying temperature is less than 180° C., it may be difficult for a coating film by the catalyst coating solution to be stably formed on the surface of the pre-coated insulating material supports. In addition, when the drying temperature exceeds 220° C., heat or more sufficient for the catalyst coating solution to form a coating film on the surface of the pre-coated insulating material supports may be applied, which may result in a decrease in process efficiency due to unnecessary energy use. In addition, when the drying time is less than 0.5 hours, a coating film by the catalyst coating solution may not be stably formed on the surface of the pre-coated insulating material supports, and when the drying time exceeds 1.5 hours, after a coating film by the catalyst coating solution is sufficiently formed on the surface of the pre-coated insulating material supports, a decrease in process efficiency due to unnecessary energy use may occur.

In the catalyst coating step (S4), the catalyst coating impregnation step and the catalyst coating drying step may be repeated one or more times. For example, the catalyst coating impregnation step and the catalyst coating drying step may be repeated one or more times until the coating amount calculated by calculating the density difference based on the weight difference between the pre-coated insulating material supports on which the catalyst coating drying step has been completed and the pre-coated insulating material supports before the catalyst coating step (S4) is introduced becomes 20 to 40 kg/m³ (0.02 to 0.04 g/cm³). At this time, since the thickness coated on the pre-coated insulating material supports in the catalyst coating step (S4) is very low, the change in volume can be ignored when calculating the density difference. Accordingly, the reforming catalyst can be effectively prepared.

As the catalyst coating step (S4) after performing the pre-coating step (S2) is performed, the strength of the insulating material supports can be secured, thereby providing a catalyst with excellent durability. For example, if only the catalyst coating step (S4) is performed without the pre-coating step (S2), sufficient strength of the insulating material supports cannot be secured. In addition, since the catalyst material required for the reforming catalyst cannot be imparted if only the pre-coating step (S2) is performed, the reforming catalyst cannot be used as a catalyst.

In addition, in the pre-coating step (S2) and the catalyst coating step (S4), coating can be efficiently performed on the insulating material supports while maintaining the characteristics of the insulating material supports, such as heat resistance and stable properties even in high-temperature reactions by using the pre-coating solution and the catalyst coating solution having the same main components as the insulating material supports.

The organic material removal step is a step for removing residual organic materials that may be included in the reforming catalyst that has completed the catalyst coating step (S4). In particular, when an aqueous solution containing organic materials is used in the pre-coating solution and the catalyst coating solution, it is preferable to apply the organic material removal step.

The organic material removal step may be applied with various heating furnaces to which hot air heating, infrared heating, and a combination thereof are applied, but the present disclosure is not limited thereto. At this time, the heating condition is preferably maintained at 550 to 750° C. for 2 to 4 hours. For example, if the temperature is lower than 550° C., the organic materials contained in the reforming catalyst may not be sufficiently removed, and if the temperature exceeds 750° C., the process efficiency may decrease due to unnecessary energy use due to not lower than a temperature sufficient to remove the organic materials contained in the reforming catalyst. In addition, if the organic material removal step is performed for less than 2 hours, the organic materials contained in the reforming catalyst may not be sufficiently removed, and if the organic material removal step is performed for more than 4 hours, the process is conducted for a period of time sufficient or longer to remove the organic materials contained in the reforming catalyst so that the process efficiency may decrease due to unnecessary energy use and excessive time consumption.

Hereinafter, the present disclosure will be described in more detail through Manufacturing Examples, Examples, Comparative Examples, and Experimental Examples. However, the following Examples are only intended to aid understanding of the present disclosure and the scope of the present disclosure is not limited to these Examples in any way.

### Manufacturing Examples: Manufacturing of Pre-Coated Insulating Material Supports

Insulating material support: Using insulating material processed into a cubic shape with Al₂O₃ 46 to 85%, SiO₂ 25 to 54%, density 350±10% kg/m³, and a side length of 6 mm.

Silica sol: Using the mixture by mixing silica sol SS-30SG (SKemtech), SS-30A (SKemtech), and SS-30 (SKemtech) with SiO₂ particle content of 29 to 31% by weight and SiO₂ particle size of 10 to 20 nm.

Alumina sol: Using alumina sol (Alintech) with Al₂O₃ particle content of 5 to 20% by weight and Al₂O₃ particle size of 20 to 150 nm.

### Water: Distilled Water

Catalyst powder: Al—Ru 3% (alumina-ruthenium 3%), processed into powder form of less than 10 μm

Pre-coating impregnation step conditions: Pre-coating solution: insulating material support=2:1 volume ratio, stirring speed of 150 RPM, impregnation temperature of 20° C., impregnation is performed until no bubbles are generated in the insulating material

Pre-coating drying step conditions: Hot air drying, temperature of 180 to 220° C., drying time of 1 hr

A pre-coating step satisfying the pre-coating impregnation step conditions and the pre-coating drying step conditions was performed so that the coating amount on the insulating material supports reached 250 kg/m³ based on the content of the pre-coating solution described in Table 1 by using the insulating material supports, the silica sol, the alumina sol, water, and the catalyst powder, thereby manufacturing pre-coated insulating material supports.

TABLE 1

| | Pre-coating solution content | | | |
|---|---|---|---|---|
| | | Alumina sol | | Catalyst |
| Classification | Silica sol (g) | (g) | Water (g) | powder (g) |
| Manufacturing | 100 | 75 | 25 | 2 |
| Example 1 | | | | |
| Manufacturing | 90 | 85 | 25 | 2 |
| Example 2 | | | | |
| Manufacturing | 110 | 65 | 25 | 2 |
| Example 3 | | | | |
| Manufacturing | 100 | 75 | 25 | 0 |
| Example 4 | | | | |

### Example: Preparation of Reforming Catalyst

Silica sol: Mix and use silica sol SS-30SG (SKemtech), SS-30A (SKemtech), and SS-30 (SKemtech) with SiO₂ particle content of 29 to 31% by weight and SiO₂ particle size of 10 to 20 nm.

Alumina sol: Using alumina sol (Alintech) with Al₂O₃ particle content of 5 to 20% by weight and Al₂O₃ particle size of 20 to 150 nm.

Water: Distilled water

Catalyst powder: Al—Ru 3% (alumina-ruthenium 3%), processed into powder form of less than 10 μm

Firing step conditions: Hot air drying, temperature of 850° C., firing time of 6 hr

Catalyst coating mixing conditions: Catalyst coating solution: Insulating material support=2:1 volume ratio, stirring speed of 150 RPM, impregnation temperature of 20° C., impregnation is performed until no bubbles are generated in the insulating material

Catalyst coating drying conditions: Hot air drying, temperature of 200° C., drying time of 1 hr

A firing step satisfying the firing step conditions was performed on the pre-coated insulating material supports manufactured in Manufacturing Examples 1 to 4. Subsequently, a catalyst coating step satisfying the catalyst coating impregnation step conditions and the catalyst coating drying step conditions based on the catalyst coating solution content described in Table 2 was performed on the pre-coated insulating material supports completing the firing step, using the silica sol, the alumina sol, water, and the catalyst powder, so that the coating amount on the pre-coated insulating material supports reached 30 kg/m³ (0.03 g/cm³), thereby preparing reforming catalysts.

TABLE 2

| | Pre-coated | Catalyst coating solution content | | | |
|---|---|---|---|---|---|
| | insulating | Silica | | | Catalyst |
| | material | sol | Alumina | Water | powder |
| Classification | support | (g) | sol (g) | (g) | (g) |
| Example 1 | Manufacturing | 1 | 2 | 100 | 10 |
| | Example 1 | | | | |
| Example 2 | Manufacturing | 2 | 4 | 100 | 10 |
| | Example 2 | | | | |
| Example 3 | Manufacturing | 4 | 2 | 100 | 10 |
| | Example 3 | | | | |
| Example 4 | Manufacturing | 1 | 2 | 100 | 10 |
| | Example 4 | | | | |

### Comparative Examples 1 to 5: Preparation of Reforming Catalysts

A pre-coating step satisfying the same pre-coating impregnation step conditions and pre-coating drying step conditions as in Manufacturing Examples was performed based on the pre-coating solution contents described in Table 3 by using the same silica sol, alumina sol, water, and catalyst powder as in Manufacturing Examples above, thereby manufacturing pre-coated insulating material supports.

Subsequently, a firing step satisfying the same firing step conditions as in Examples above was performed on the pre-coated insulating material supports, and a catalyst coating step satisfying the same catalyst coating impregnation step conditions and catalyst coating drying step conditions as in Examples above was performed on the pre-coated insulating material supports that completed the firing step based on the content of the catalyst coating solution described in Table 3 by using the same silica sol, alumina sol, water, and catalyst powder as in Examples above, thereby preparing reforming catalysts.

TABLE 3

| | Classification | | | | | | | |
|---|---|---|---|---|---|---|---|---|
| | Pre-coating solution | | | | Catalyst coating solution | | | |
| | content | | | | content | | | |
| | | | | Cata- | | | | Cata- |
| | | Alum- | | lyst | | Alum- | | lyst |
| | Silica | ina | | pow- | Silica | ina | | pow- |
| | sol | sol | Water | der | sol | sol | Water | der |
| | (g) | (g) | (g) | (g) | (g) | (g) | (g) | (g) |
| Comparative | 150 | 25 | 25 | 2 | 1 | 2 | 100 | 10 |
| Example 1 | | | | | | | | |
| Comparative | 175 | 0 | 25 | 2 | 1 | 2 | 100 | 10 |
| Example 2 | | | | | | | | |
| Comparative | 125 | 50 | 25 | 2 | 1 | 2 | 100 | 10 |
| Example 3 | | | | | | | | |
| Comparative | 75 | 100 | 25 | 2 | 1 | 2 | 100 | 10 |
| Example 4 | | | | | | | | |
| Comparative | 87.5 | 87.5 | 25 | 2 | 1 | 2 | 100 | 10 |
| Example 5 | | | | | | | | |

### Experimental Example 1: Performing CH₄ Reforming Reactions of Reforming Catalysts

The reforming catalysts prepared through Examples 1 to 4 above and Comparative Examples 1 to 5 above were used to perform the CH₄ reforming reactions under the same SCR (Steam to Cabon Ratio) reaction conditions, and conditions of GHSV (Gas Hourly Space Velocity) 2000, and reforming reaction temperature 750° C., and in order to compare the catalytic effect and the stability over time, CH₄ gases (mol %) were measured and the results are shown in Table 4.

TABLE 4

| CH₄ gas | | | | |
|---|---|---|---|---|
| (mol %) | 5 hours | 10 hours | 15 hours | 20 hours |
| Example 1 | 0.21 | 0.22 | 0.21 | 0.23 |
| Example 2 | 0.47 | 0.47 | 0.47 | 0.46 |
| Example 3 | 0.69 | 0.69 | 0.69 | 0.69 |
| Example 4 | 0.33 | 0.38 | 0.37 | 0.38 |
| Comparative | 0.41 | 0.45 | 0.49 | 0.51 |
| Example 1 | | | | |
| Comparative | 0.43 | 0.46 | 0.49 | 0.51 |
| Example 2 | | | | |
| Comparative | 0.34 | 0.37 | 0.44 | 0.47 |
| Example 3 | | | | |
| Comparative | 0.28 | 0.24 | 0.24 | 0.34 |
| Example 4 | | | | |
| Comparative | 0.61 | 0.59 | 0.59 | 0.65 |
| Example 5 | | | | |

Referring to Table 4, when the reforming catalysts according to the present disclosure were applied, it can be confirmed that the change in the CH₄ gas (mol %) concentrations over time (Examples 1 to 4) was very small. Accordingly, the stability of the reforming catalyst applied with the insulating material support over time can be confirmed.

In contrast, it can be confirmed that the change in the CH₄ gas (mol %) concentrations over time in Comparative Examples 1 to 5, which deviate from the appropriate ratio of silica sol and alumina sol, increases as time goes by, confirming that the thermal stability is poor.

In addition, when comparing Example 1, which includes a catalyst powder in the pre-coating solution, and Example 4, which does not include a catalyst powder in the pre-coating solution among the reforming catalysts according to the present disclosure, it can be confirmed that the CH₄ gas (mol %) values over time are stably maintained in both Example 1 and Example 4, but since the CH₄ gas (mol %) value of Example 1 is relatively low, it can be confirmed that there is a difference in the reaction amount. Accordingly, it can be confirmed that when a catalyst powder is applied to the pre-coating solution, the catalytic reaction of the reforming catalyst to which the insulating material support is applied may occur more effectively.

### Comparative Example 7: Pellet-Type Catalyst

A pellet-type catalyst containing 30 g of Al—Ru 3% (alumina-ruthenium 3%) based on the catalyst amount that had been processed into a pellet shape of 2 to 3 mm in size was applied.

### Experimental Example 2: Performing CH₄ Reforming Reactions of Reforming Catalysts

The reforming catalyst (9 g based on catalyst amount) prepared through Example 1 above and the pellet-type catalyst of Comparative Example 7 above were used to perform CH₄ reforming reactions under the same SCR (Steam to Cabon Ratio) reaction conditions, and conditions of GHSV (Gas Hourly Space Velocity) 2000, and reforming reaction temperature 750° C., and in order to compare the catalytic effect and the stability over time, CH₄ gases (mol %) were measured and the results are shown in Table 5.

TABLE 5

| CH₄ gas | | | | |
|---|---|---|---|---|
| (mol %) | 5 hours | 10 hours | 15 hours | 20 hours |
| Example 1 | 0.21 | 0.22 | 0.21 | 0.23 |
| Comparative | 0.31 | 0.33 | 0.33 | 0.34 |
| Example 7 | | | | |

Referring to Table 5, when the reforming catalyst according to the present disclosure was applied (Example 1) and the conventional catalyst type, the pellet-type catalyst (Comparative Example 7), was applied, it can be confirmed that the CH₄ gas (mol %) concentration was maintained constant over time, and it can be confirmed that the reaction amount was also similar.

However, in order to obtain a similar reaction amount, the conventional catalyst type, the pellet-type catalyst (Comparative Example 7), was injected in a catalyst amount about 70% more than the reforming catalyst to which the insulating material support according to the present disclosure was applied. This means that in the production of 1 kW of power based on the fuel cell, about 90 g of catalyst was injected the reforming catalyst to which the insulating material support according to the present disclosure was applied, while about 300 g of catalyst should be injected to the conventional catalyst type, the pellet-type catalyst. Accordingly, when applying the reforming catalyst to which the insulating material support according to the present disclosure was applied, the amount of expensive catalyst used could be reduced, thereby securing price competitiveness.

### Experimental Example 3: Performing CH₄ Reforming Reactions of Reforming Catalysts for a Long Time

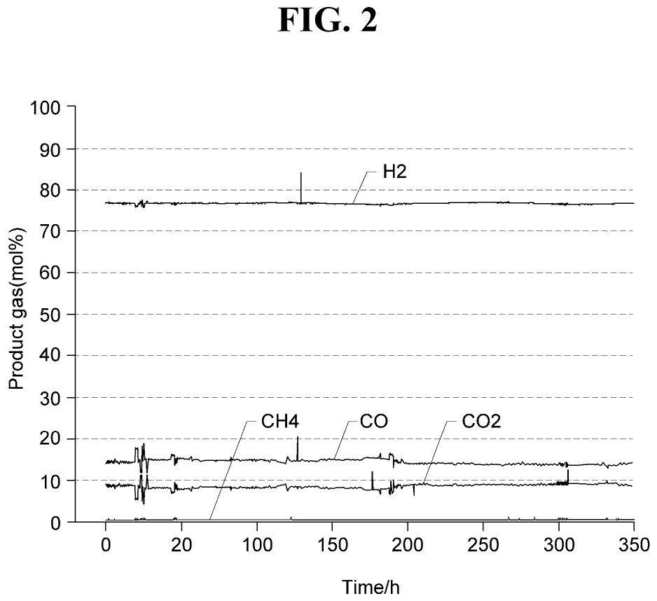

The reforming catalyst prepared through Example 1 above was used to perform CH₄ reforming reactions under the same SCR (Steam to Cabon Ratio) reaction conditions, and conditions of GHSV (Gas Hourly Space Velocity) 2000, and reforming reaction temperature 750° C., and in order to compare the catalytic effect and the stability over time, H₂, CO, CO₂, and CH₄ gases (mol %) were measured for 350 hours, and the results are shown in FIG. 2.

Referring to FIG. 2, it can be confirmed that when the reforming catalyst according to the present disclosure is applied (Example 1), the reaction occurs stably even when the reaction is performed at a high temperature for a long time.

Through Experimental Examples 1 to 3 above, the effective compositions of the coating solutions of the reforming catalysts applied with the insulating material supports according to the present disclosure can be confirmed, and it can be confirmed that they are effective and stably exhibited compared to the conventional pellet-type catalyst.

The specific description of the present disclosure has been made by Examples referring to the attached drawings as described above, but the above-described Examples are only described as preferred examples of the present disclosure, so the present disclosure should not be understood as being limited to Examples above, and the scope of the rights of the present disclosure should be understood by the claims described below and their equivalent concepts.

1. (canceled)

2. (canceled)

3. (canceled)

4. (canceled)

5. A catalyst coating solution comprising:
an inorganic binder which is coated on a pre-coated insulating material support, and contains a silica sol and an alumina sol; and
a catalyst aqueous solution comprising a solvent and a catalyst powder,
wherein the pre-coated insulating material support is formed by coating a pre-coating solution containing a silica sol and an alumina sol on an insulating material support containing silica and alumina.

6. The catalyst coating solution of claim 5, wherein the catalyst aqueous solution has the solvent and the catalyst powder mixed therein at a weight ratio of 89 to 91:9 to 11.

7. The catalyst coating solution of claim 5, wherein the catalyst coating solution comprises:
2.6 to 5.2% by weight of the inorganic binder; and
a balance of the catalyst aqueous solution,
wherein the inorganic binder has the silica sol and the alumina sol mixed therein at a weight ratio of 1 to 5:0 to 4.

8. A reforming catalyst which is formed by coating a catalyst coating solution including an inorganic binder containing a silica sol and an alumina sol and a catalyst aqueous solution on a pre-coated insulating material support, wherein the pre-coated insulating material support is formed by coating a pre-coating solution including a silica sol and an alumina sol on an insulating material support including silica and alumina.

9. A method for preparing a reforming catalyst, the method comprising:
a pre-coating step of manufacturing a pre-coated insulating material support by coating and forming a pre-coating solution containing a silica sol and an alumina sol on an insulating material support containing silica and alumina;
a firing step of heating and firing the pre-coated insulating material support; and
a catalyst coating step of preparing a reforming catalyst by coating a catalyst coating solution including an inorganic binder containing a silica sol and an alumina sol and a catalyst aqueous solution including a solvent and a catalyst powder on the pre-coated insulating material support.

10. The method of claim 9, wherein the pre-coating step includes:
a pre-coating impregnation step of impregnating the insulating material support with the pre-coating solution;
and a pre-coating drying step of drying the insulating material support after completion of the pre-coating impregnation step,
but the pre-coating impregnation step and the pre-coating drying step are included at least once.

11. The method of claim 9, wherein the firing step comprises heating the pre-coated insulating material support to increase the temperature to 700 to 1,000° C. at a temperature rising rate of 5 to 10° C., and then maintaining the temperature for 6 to 12 hours.

12. The method of claim 9, wherein the catalyst coating step includes:
a catalyst coating impregnation step of impregnating the pre-coated insulating material support with the catalyst coating solution; and
a catalyst coating drying step of drying the pre-coated insulating material support after the catalyst coating impregnation step is completed,
but the catalyst coating impregnation step and the catalyst coating drying step are included at least once.

13. The method of claim 9, further comprising an organic material removal step of heating the reforming catalyst at 550 to 750° C. for 2 to 4 hours to remove residual organic materials.
